(19) United States
(12) Patent Application Publication
(10) Pub. No.: US 2008/0118703 A1
(43) Pub. Date: May 22, 2008

(54) Removable Surface Covering

(76) Inventor: Vicente Sansano Marti, Onda (Castelloe) (ES)

Correspondence Address: WENDEROTH, LIND & PONACK, L.L.P., 2033 K STREET N. W., SUITE 800, WASHINGTON, DC, 20006-1021, US

(21) Appl. No.: 11/660,506

(22) PCT Filed: Aug. 12, 2005
(86) PCT No.: PCT/ES05/00458

§ 371 Date: Nov. 19, 2007

(30) Foreign Application Priority Data
Aug. 20, 2004 (ES) P200402065
Feb. 8, 2005 (ES) P200500247
Jun. 10, 2005 (ES) P200501392

(51) Int. Cl. B32B 7/00

(52) U.S. Cl. 428/119

(57) ABSTRACT

The invention relates to a removable surface covering comprising a combination of lower supports with plastic support legs and upper ceramic parts which are joined to the supports by means of contact faces and with the aid of an adhesive material, such as to form covering modules which are interconnected using tongue-and-groove anchoring elements. According to the invention, the plastic supports and the ceramic parts are joined using a thick layer of adhesive which covers almost all of the contact surfaces thereof. In addition, the ceramic parts are equipped with channels and a peripheral notch which house respectively ribs and a frame belonging to the plastic support. The thickness of the adhesive extends over at least part of the thickness of the ribs and the frame of the plastic support. In another embodiment of the invention, the parts are joined at strategic points with a chemical-mechanical connection.

### OBJECT OF THE INVENTION

As stated in the title of this specification, the following invention relates to a removable surface covering applicable essentially to floors, terraces, etc., which has the feature of being easily removable and of permitting proper run-off of water and liquids that might fall onto its surface.

These qualities make it particularly applicable to outdoor surfaces subject to rain and to swimming pool water, for example.

Provision is also made for its being laid indoors, and even, with due adaptations, for covering vertical surfaces.

So, it can be said that it is applicable in general to the following surfaces:
Outdoors for swimming pools, terraces and gardens.
Indoors for the home.
Sailing boats.
Premises for handling foods (cold storage rooms, industrial kitchens, etc.).
Pedestrian areas in ports and beaches.

Moreover, the inventive covering is not just used as a drainage system but also as a system for the laying of ceramic using plastic and ceramic materials together.

An objective of the invention is to achieve a solid join between the pairs of parts that are connected together via one of their faces.

Each pair of parts comprises an upper flat ceramic body and another base body with small legs for resting on the floor defining a run-off chamber for the water which falls on the covering and reaches as far as the separation channels demarcating the ceramic parts.

Another objective is to achieve a better and faster drainage of the water or liquid falling on the free surface of each ceramic part.

A further objective of the invention is to successfully compensate the small dimensional variations which ceramic parts can undergo during the manufacturing process.

Another improvement is the possibility of vertically extracting each ceramic part without any need to act on the adjacent ones, which implies a major advantage when it comes to exchanging parts due to breakage, or due to a desire to change one covering for another.

Another objective of the invention is the reinforcement of the actual decorative part endowing it with greater adherence and securing in its connection to the plastic support and, on an accessory basis, providing the assembly with better thermal and sound insulation qualities.

We thus obtain a new covering with high resistance to impact, along with good grip in the join between the different component parts of the covering.

### PRIOR ART OF THE INVENTION

There currently exist different coverings for floors, standing out among which are those which are applied to outdoor surfaces in order to facilitate the run-off of rainwater and also in areas around swimming pools.

In some cases, the coverings consist of plastic parts with a hollow structure with a certain thickness which define a lower run-off chamber (S1017449).

These coverings can present problems of hygiene, and at the same time they leave a great deal to be desired at the aesthetic level.

In other case, the coverings comprise bodies manufactured from porous materials, which, although it is true that they are capable of draining off a certain flow of water, a certain point is reached at which saturation takes places. Also, the porosity of those bodies in some cases facilitates the proliferation of fungi and bacteria.

Also known are coverings formed from lower base parts of a plastic material and upper parts of a ceramic material, notable among which are invention patents numbers WO03/040491, EP044371, EP256189 and DE199662812.

These coverings present certain problems, for example, difficulties when it comes to exchanging ceramic parts due to breakage or for any other reason.

### DESCRIPTION OF THE INVENTION

In order to achieve the objectives and avoid the drawbacks mentioned in the previous section, the invention proposes a removable surface covering wherein it comprises in principle a combination of lower support elements for drainage and upper plates which are fixed on those support bodies, such that when water falls on that covering, whether it be rainwater, swimming pool water or any other, the water does not remain on the visible exterior surface but instead reaches the lower chamber formed by the support elements for drainage via some separation grooves between the plates when these are made of a ceramic or similar material.

This combination of elements provides an inhibiting covering, both for damp and for water retention thanks to the fact that the water which has fallen reaches the lower chamber formed by the support elements made essentially of plastic material.

It is also a hygienic product thanks to the inclusion of the upper plates which are the ones arranged externally.

The support elements basically comprise a flat structure with passage windows or spaces containing an array of short support legs, the side edges also including means of engagement with other adjacent support elements.

When the plates are ceramic parts, they are fixed to the lower supports leaving some separation grooves between them so that the water can, via those grooves, reach the lower chamber corresponding to the supports, thus achieving proper run-off or flow of liquid to drain.

Another possibility could be that the ceramic parts are in contact along their entire side edges and those parts include small passage windows so that the water can reach the lower chamber.

Another possibility is that the ceramic parts include channels, the bottoms of which have a certain descending inclination towards the perimeter of the ceramic parts with the aim of encouraging the water to fall towards the separation grooves or joints between the ceramic parts and thereby facilitate the run-off of the water.

The material used for the support elements will preferably be low density polyethylene, though it could be any other.

Another characteristic of the invention is that the connection between the upper plates and the support elements consists of applying an adhesive material at strategic points during the pressing of each pair of parts, in correspondence with some hollows in the support element and some slots in the upper plates, such that when the adhesive material hardens a chemical-mechanical connection is obtained.

This connection is very solid and at the same time it is possible to detach and separate the plates when necessary without interfering with the adjacent plates. The connection material adopts a structure like a rivet, so that when an upper part needs to be separated, the breakage takes place of just the connection material corresponding to the different strategic points of that connection.

This connection system economises on sticking material and at the same time permits a certain tolerance towards movements. It also allows the ceramic part or parts to be removed vertically for being exchanged.

Another characteristic of the invention is that the visible surfaces of the ceramic parts are slightly swollen in order to improve the fall of the water towards the side edges of those parts.

In any case, the aim is for the highest point of that visible surface to be higher than the rest of it. To achieve this, another possibility could be for it to consist of a surface shaped like a multiple-pitch roof.

Another improvement is that the support element has a width and length slightly greater than those of the ceramic part, all this with the aim of compensating for the minor dimensional variations which those ceramic parts can undergo during the pressing stage of manufacture.

The ceramic parts can include furrows, the ends of which lead to the edges of those parts in order to improve the drainage. The bottom of those furrows presents a slight inclination, and they can also have a bottom profile shaped like a double-pitch roof.

The support elements include lateral fastenings in their edges for being able to be screwed to a lower surface corresponding to the floor, if necessary.

So, each set of support and tile comprises a covering tile module which is connected and associated with other adjacent modules by means of a tongue-and-groove coupling.

The connection between both parts of each module is done by means of tongue portions of the support which are complemented with groove portions located on the reverse side of the ceramic parts, thereby achieving a combined chemical-mechanical connection.

The inventive covering is also wherein the plastic supports comprise a structure formed from an array of coplanar ribs and a peripheral frame with a staggered configuration, said ribs being complemented with some channels located on the reverse side of the ceramic parts, so that when the adhesive is poured over the contact surface between the two component bodies of the module the mechanical and chemical connection is made precisely via the said ribs and channels with the addition of the adhesive.

The connection between the ceramic part and the plastic support is reinforced by means of a succession of small passage recesses located in an interior portion of the peripheral frame of the support, which will also receive adhesive. The reverse side of the ceramic parts in turn presents a peripheral notch corresponding to the plastic support. The adhesive layer is applied covering at least all the lower surface demarcated by the frame of the support, and the adhesive layer in turn exceeds the support ribs which remain embedded in it, achieving the desired mechanical and chemical fastening, in turn generating a reinforcing volume or lamina in the tile which stiffens it considerably, eliminating all the problems of impact resistance and also granting the unit certain thermal and sound insulating qualities that are highly advantageous for certain applications.

Moreover, in the join of the short legs with the ribs, some small tronco-conical enlargements are generated which correspond to other complementary depressions of the ceramic parts located along the channels. The ribs of the supports include other tronco-conical enlargements. In this way, a more consistent and solid mechanical connection is achieved, since these enlargements are completely embedded without the adhesive.

The short legs are also to be found in the peripheral frame, which also includes the elements for carrying out the tongue-and-grooving between the different modules.

Finally, provision has been made for some narrow profiles arranged in the free edges of the covering in correspondence with the different modules, in which case they serve to terminate the covering of those sides which do not end in a wall or surface that can cover them.

These narrow profiles include some anchoring extensions to the peripheral legs of the plastic supports.

Below, in order to aid a better understanding of this specification and forming an integral part thereof, some figures are attached in which, on an illustrative rather than limiting basis, the object of the invention has been represented.

### BRIEF DESCRIPTION OF THE DRAWINGS

FIG. 1.—Shows an exploded perspective view of the removable surface covering, forming the object of the invention.

FIG. 2.—Shows a sectioned elevation view of the covering represented in the previous figure.

FIG. 3.—Shows another sectioned view of the covering of the invention.

FIG. 4.—Shows an exploded perspective view of the removable covering with a different embodiment from that shown in the previous figures.

FIG. 5.—Shows a sectioned view of that represented in the previous figure.

FIG. 6.—Shows another sectioned view of the covering shown in FIG. 4.

FIG. 7.—Shows a plan view of the reverse side of a ceramic part which forms part of the removable surface covering. In this embodiment, the covering basically comprises a base support with short support legs and a ceramic part which is joined to the base support by means of an adhesive layer.

FIG. 8.—Shows a perspective view of a plastic support which forms part of the covering shown in the previous figure.

FIG. 9.—Shows a perspective view of the unit of a ceramic part and plastic support with the inclusion of some narrow terminal profiles for decoration and finishing.

FIGS. 10 and 11.—Represent respective sectioned details essentially showing the connection of the ceramic part and plastic support by means of the corresponding adhesive.

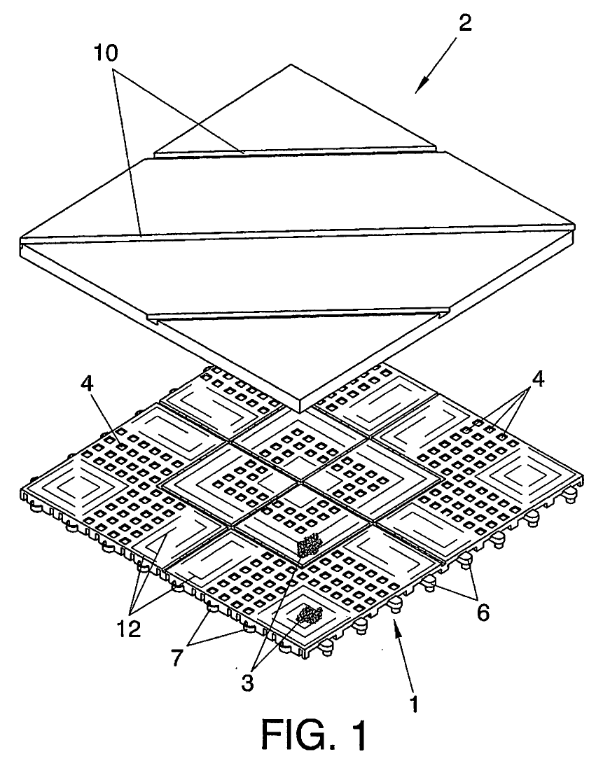

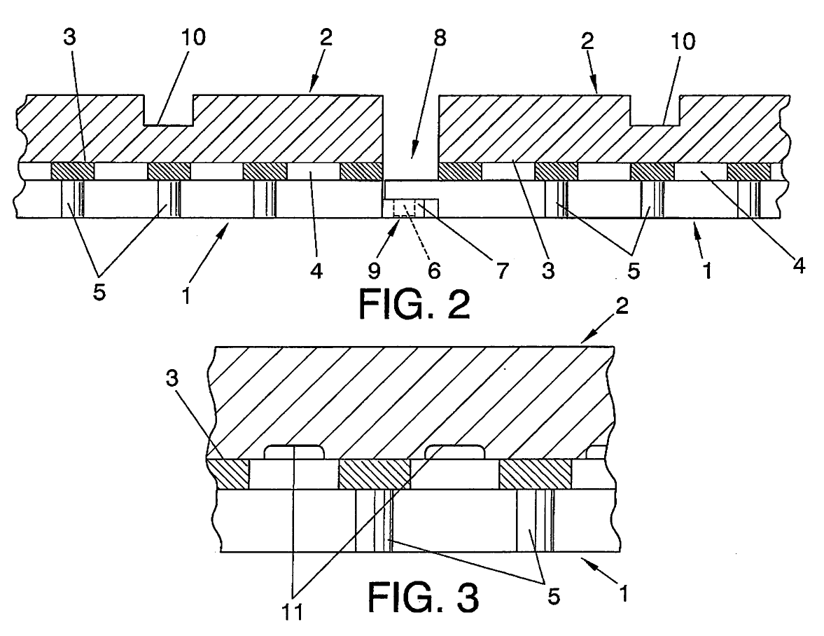

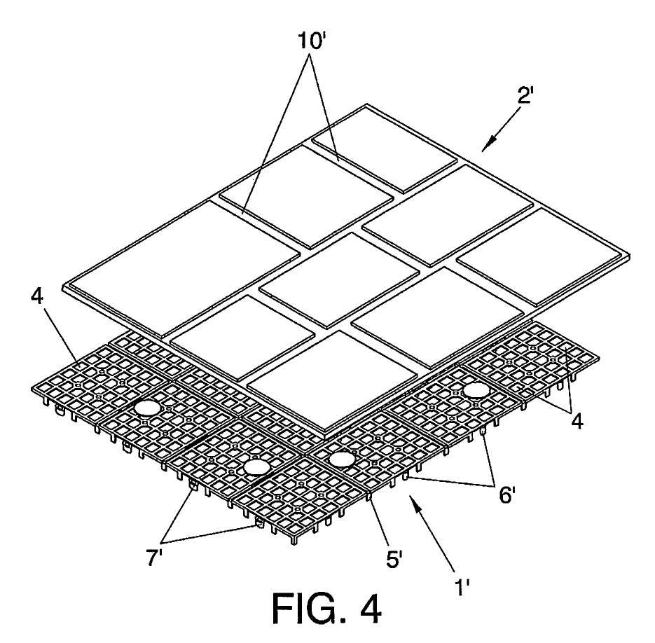

### DESCRIPTION OF THE PREFERRED FORM OF EMBODIMENT

Considering the numbering adopted in the figures, the removable surface covering comprises the combination of some plastic support legs 1, 1′, 1″ and some upper ceramic supports 2. 2′, 2″, the two being joined via their contact faces by means of an adhesive 3, or any other means. These plastic supports include some short legs 5, 5′, 5″ for resting on the ground.

In a first embodiment, the lower supports 1 include a set of passage windows 4 and also the short support legs 5 on the ground, thereby creating a run-off chamber for rainwater, swimming pool water, etc. The supports 1 also include some grooves 12.

The lower parts 1 in turn possess complementary anchoring elements 6 and 7 for associating the different lower parts 1 together.

Moreover, the edges of the upper parts 2 coincide with the edges of the lower supports 1, such that between the upper parts 2 some separation channels 8 are created which coincide with other separation channels 9 existing between the lower parts, these latter channels 9 being where the anchoring elements 6 and 7 between the different lower parts 1 are to be found.

In this way, the water which falls on the ceramic parts 2 will reach as far as the run-off chamber precisely via the peripheral channels demarcating and separating the different parts.

In addition, the ceramic parts 2 can include some furrows 10, which lead to the peripheral channels, and at the same time those furrows possess a gentle and slight inclination descending towards the edges of the said ceramic parts 2.

Moreover, the lower face of the ceramic parts 2 can include depressions 11 which will be complemented with projections of the plastic supports 1 for improving the resistance to movement between the parts, as well as the connection and immobilisation of the said parts.

The distribution of the short support legs 5 of the lower supports 1 permit the load to be borne by the covering to be distributed, such that it can be transited even by vehicles.

In a second embodiment, the adhesive material 3 is located in correspondence with some slots 13 of the ceramic parts 2′ and in correspondence with some facing hollows of the lower parts 1′.

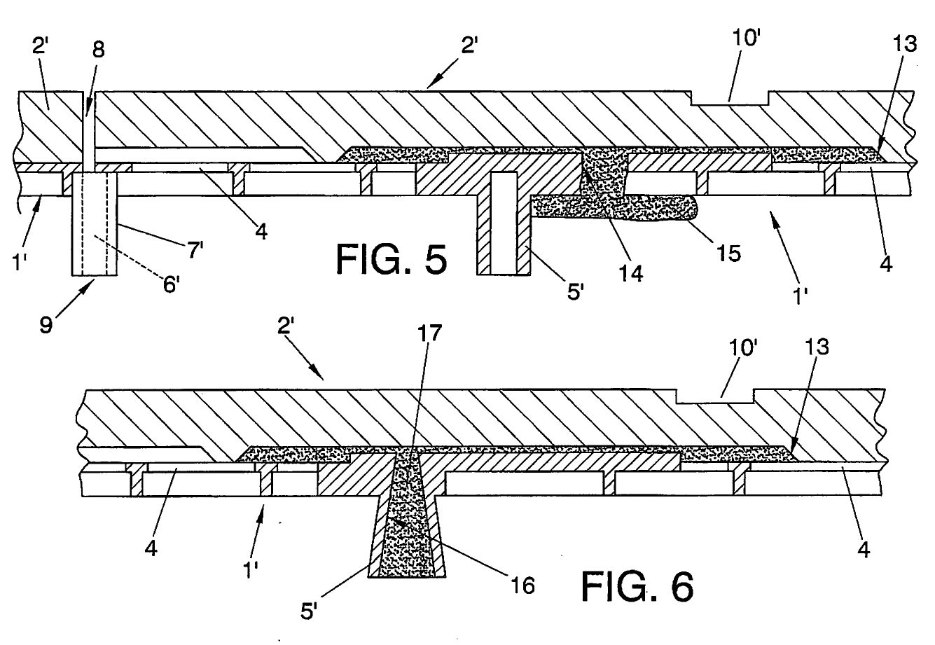

Paying attention to FIG. 5, the hollows consist of some passage openings 14, such that, when the two parts are pressed together in order to proceed to their joining, the adhesive material, still soft, will adopt a structure in the form of a mushroom 15 by way of a rivet, in such a way that when the adhesive dries, a chemical and mechanical connection will be obtained via the different points where the adhesive has been applied.

Paying attention now to FIG. 6, the hollows consist of some conical shaped openings 16, in such a way that when the adhesive dries a solid fastening with a rivet structure 17 is also obtained.

The lower supports 1′ include the set of passage windows 4, along with the short support legs 5′ on the ground, thereby creating a run-off chamber for rainwater, swimming pool water, etc., as occurred in the first embodiment.

The lower parts 1′ in turn possess complementary anchoring elements 6′ and 7′ for associating the different lower parts 1′ together.

Moreover, the edges of the upper parts 2′ are in correspondence with the edges of the lower supports 1′, such that, as occurred in the first embodiment, between the upper parts 2′ some separation channels 8 are created which coincide with other separation channels 9 existing between the lower parts, these latter channels 9 being where the anchoring elements 6′ and 7′ between the different lower parts 1′ are to be found.

In this way, the water which falls on the ceramic parts 2′ will reach as far as the run-off chamber precisely via the peripheral channels demarcating and separating the different parts.

In addition, the ceramic parts 2′ can include some furrows 10′, which lead to the peripheral channels, and at the same time those furrows possess a gentle and slight inclination, either descending towards the edges of the said ceramic parts 2′ or pairs of descending planes like a double-pitch roof.

The distribution of the short support legs 5′ of the lower supports 1′ permit the load to be borne by the covering to be distributed, such that it can be transited even by vehicles.

The decorative free surface of the ceramic parts 2′ is higher in the middle in order to facilitate the drainage of water. It can be a swollen surface, a surface shaped like a quadruple-pitch roof or similar.

The plastic support 1′ includes in at least one of its sides a projecting opening which exceeds the perimeter of the ceramic part (similar to the anchorings) for the use of mechanical fastenings to the floor or wall. This permits the covering to be secured in zones where it could slip if it is simply held in position with the fastenings offered by the supports.

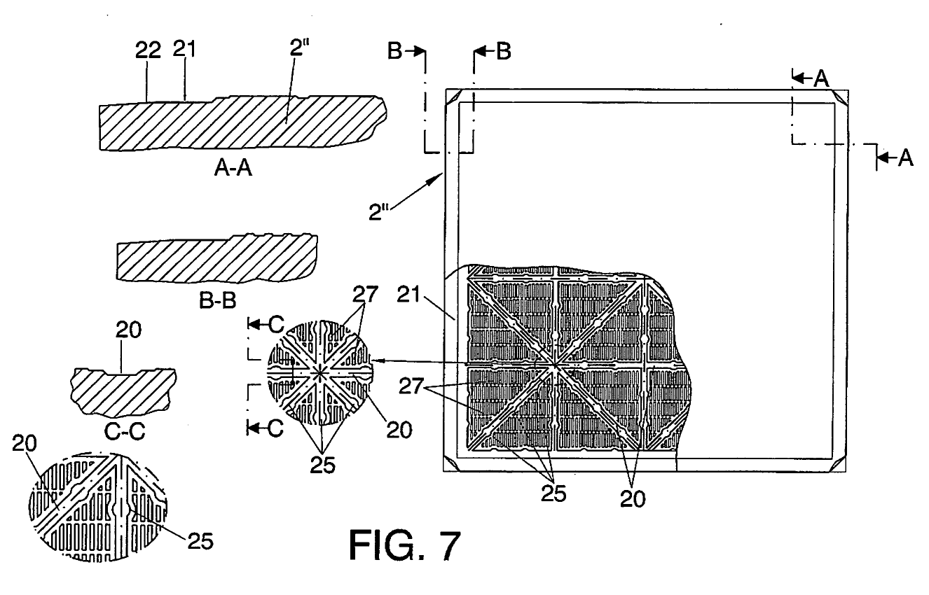

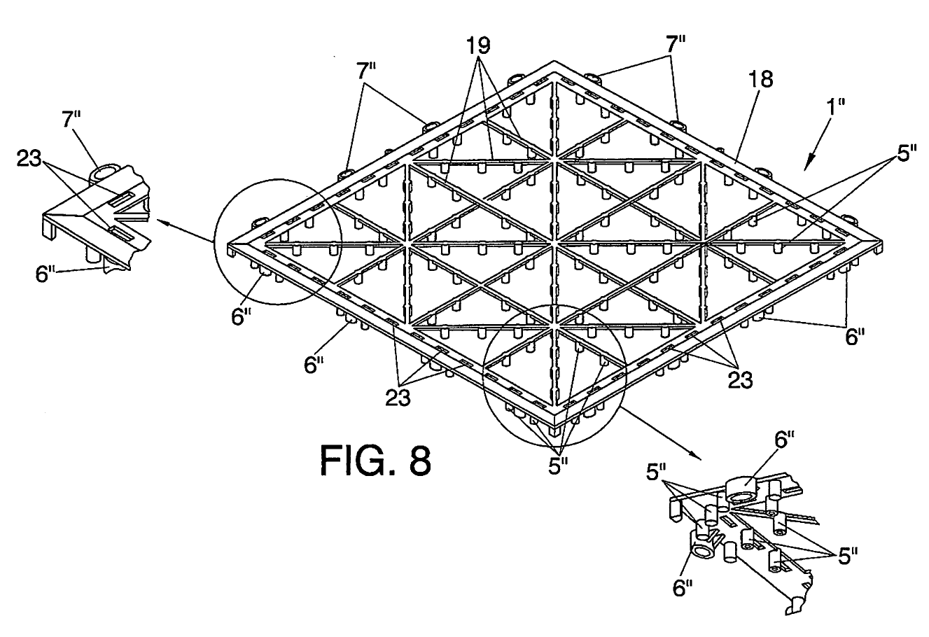

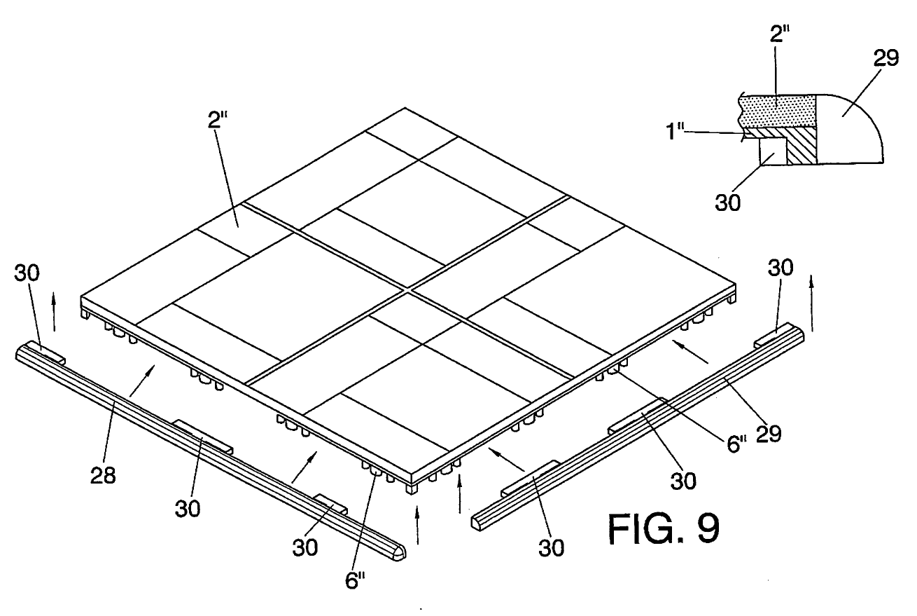

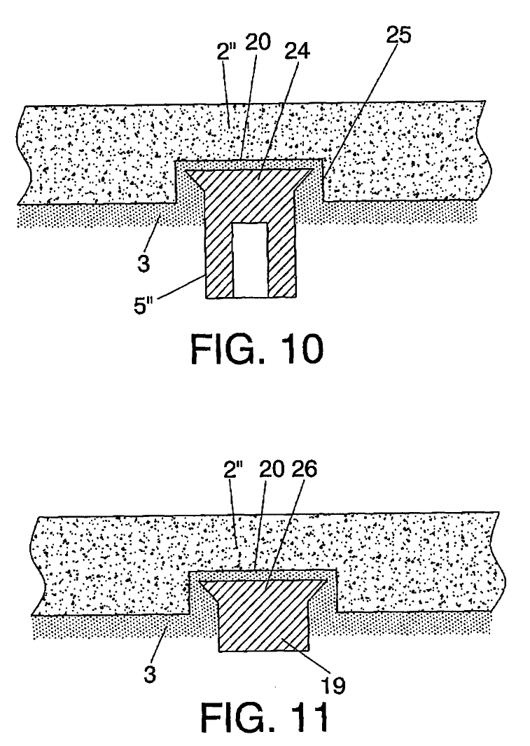

In a third embodiment (FIGS. 7, 8, 9, 10 and 11) the removable covering comprises plastic supports 1″ and some upper parts of a ceramic nature 2″, which are connected via their contact faces by means of a thick layer of adhesive 3 which will cover virtually the entire contact surface of both parts, constituting covering modules which will be linked by means of a tongue-and-groove connection made up of small tongue 6″ and groove 7″ anchoring elements integral with the plastic supports 1″.

The plastic support 1″ includes a staggered peripheral frame 18 and a cross-linkage of ribs 19 which are located in correspondence with a complementary cross-linkage of channels 20 located on the reverse side of the respective ceramic part 2″.

In turn, the peripheral frame 18 of the plastic support 1″ is located in correspondence with a peripheral notch 21 of the reverse side of the respective ceramic part 2″, said notch 21 possessing a gentle exterior inclined plane 22.

This peripheral zone also receives the adhesive 3, with part of the fastening being assured by means of a succession of small recesses 23 made in the interior portion of that frame 18 of the plastic support 1″.

The plastic support 1″ includes an array of small support legs 5″ integral with the ribs 19 and also with the peripheral frame 18.

In the confluence of the legs 5″ with the different ribs 19, some tronco-conical enlargements 24 are generated which are located in some complementary depressions 25 established along the channels 20 of the reverse side of the ceramic part 2″.

The ribs 19 of the plastic supports 1″ present in their upper part a configuration with an inverted trapezoid section 26 which, added to the tronco-conical enlargements 24, creates a stronger, more flexible and solid mechanical join, along with greater robustness and rigidity in each covering module comprising a ceramic part and plastic support.

The areas of the reverse side bounded by the channels 20 and peripheral notch 21 comprise a multitude of tronco-pyramidal prominences with rectangular bases 27 which also help to provide better fastening between the plastic support and the respective ceramic part.

Moreover, some narrow decorative profiles 28 and 29 are provided, with circular section, which serve to finish the free sides of the covering.

These profiles 28 and 29 possess some T-shaped extensions 30 in one of their faces in order to facilitate their securing to the plastic support 1″ in correspondence with some of the short legs 5″ emerging from the peripheral frame 18 of that support 1″.

1. REMOVABLE SURFACE COVERING, wherein essentially it comprises the combination of lower parts by way of supports including short legs for resting on the ground and upper parts which are connected to the supports via their contact faces, with the aid of an adhesive or similar, with some separation channels facing other separation channels between the supports being defined between the adjacent edges of the upper parts, these latter separation channels being interrupted by complementary anchoring elements of those lower supports; all this so that the water falling on the covering reaches as far as the lower run-off chamber established in correspondence with the short legs of the lower supports.

2. REMOVABLE SURFACE COVERING, according to claim 1, wherein the faces in contact with the two layers of the parts possess tongue-and-groove elements which complement each other, all this in order to achieve a better fastening between the upper and lower parts.

3. REMOVABLE SURFACE COVERING, according to claim 1, wherein the free external faces of the upper parts include some furrows with a gentle descending inclination towards the edges of those parts, in correspondence with the separation channels.

4. REMOVABLE SURFACE COVERING, according to claim 1, wherein the lower parts include a set of passage windows along with some grooves.

5. REMOVABLE SURFACE COVERING, according to claim 1, wherein the adhesive material joining the pairs of parts is applied at strategic points where the ceramic parts are provided with some slots facing some hollows made in the lower supports, in such a way that when the two parts are pressed together for their joining, the adhesive material, still soft, forms a structure by way of a rivet with the combined connection of a chemical and mechanical nature.

6. REMOVABLE SURFACE COVERING, according to claim 5, wherein the hollows of the plastic supports consist of some passage openings, the adhesive material thus giving rise to a rivet structure in the form of a double “mushroom”, where one part corresponds to the slots of the upper parts while the other part corresponds to a portion located in correspondence with the free face of the lower parts.

7. REMOVABLE SURFACE COVERING, according to claim 5, wherein the hollows of the lower parts consist of some conical shaped openings.

8. REMOVABLE SURFACE COVERING, according to claim 1, wherein the decorative free surface of the ceramic parts are higher in the middle in order to facilitate the drainage and fall of the water.

9. REMOVABLE SURFACE COVERING, according to claim 8, wherein the decorative free surface of the ceramic parts presents a gentle swelling.

10. REMOVABLE SURFACE COVERING, according to claim 8, wherein the decorative free surface of the ceramic parts presents a surface in the form of a multiple-pitch roof.

11. REMOVABLE SURFACE COVERING, according to claim 10, wherein the supports comprise a staggered frame and an array of ribs which are located in some channels of the reverse side of the ceramic parts, while the frame is located in correspondence with a peripheral notch of the reverse side of those ceramic parts, the adhesive being applied to the entire contact surface of the ceramic parts and supports with a thickness of adhesive that covers at least part of the thickness of the frame and ribs of the plastic supports.

12. REMOVABLE SURFACE COVERING, according to claim 11, wherein the ribs of the plastic supports include in their upper part a configuration with an inverted trapezoid section embedded in the adhesive material.

13. REMOVABLE SURFACE COVERING, according to claim 11, wherein the short legs starting from the ribs, where they join with the latter, shape certain inverted tronco-conical portions embedded in the actual adhesive material, these tronco-conical portions fitting in some complementary depressions located along the channels of the reverse side of the ceramic parts.

14. REMOVABLE SURFACE COVERING, according to claim 11, wherein the lower part of the staggered frame includes a succession of recesses embedded in the actual adhesive material.

15. REMOVABLE SURFACE COVERING, according to claim 11, wherein it includes some narrow decorative profiles able to be fixed in some of the most external legs integral with the staggered frame; all this in order to cover and decorate the free edges of the covering.

16. REMOVABLE SURFACE COVERING, according to claim 15, wherein the narrow decorative profiles include some T-shaped extensions as means of fastening to the legs of the plastic supports.
